(19) United States
(12) Patent Application Publication
(10) Pub. No.: US 2005/0211904 A1
(43) Pub. Date: Sep. 29, 2005

(54) Non-uniformly polished scintillation crystal for a gamma camera

(76) Inventor: Keith Ritter, Addison, IL (US)

Correspondence Address: Elsa Keller;Siemens Corporation, Intellectual Property Department, 170 Wood Avenue South, Iselin, NJ, 08830, US

(21) Appl. No.: 10/809,624

(22) Filed: Mar. 25, 2004

(51) Int. Cl. G01T 1/161

(52) U.S. Cl. 250/363.02

(57) ABSTRACT

A gamma camera is provided having an array of photodetectors and associated circuitry for detecting and converting light energy to electrical energy. The gamma camera further includes a scintillation crystal positioned in proximity to the array of photodetectors for detecting gamma photon emissions and generating light energy. At least one portion of at least one surface of the scintillation crystal is polished differently than at least another portion for yielding a substantially different light response function for the generated light energy. That is, the scintillation crystal is non-uniformly polished or has a non-uniform level of smoothness. The non-uniformly polished scintillation crystal improves signal-to-noise ratio and image quality with respect to spatial resolution.

### BACKGROUND OF THE INVENTION

1. Field of the Invention

The present invention generally relates to nuclear medicine, and a gamma camera for obtaining nuclear medicine images of a patient's body organs of interest. In particular, the present invention relates to a gamma camera for obtaining nuclear medicine images by detecting radiation events emanating from a patient and having a non-uniformly polished scintillation crystal capable of providing at least two different light response functions.

2. Description of the Related Art

Nuclear medicine is a unique medical specialty wherein radiation is used to acquire images which show the function and anatomy of organs, bones or tissues of the body. Radiopharmaceuticals are introduced into the body, either by injection or ingestion, and are attracted to specific organs, bones or tissues of interest. Such radiopharmaceuticals produce gamma photon emissions which emanate from the body.

Conventional gamma cameras utilize a scintillation crystal (usually made of thallium-activated sodium iodide (Nal(TI))) which absorbs the gamma photon emissions and emits light photons (or light events) in response to the gamma absorption. An array of photodetectors, such as photomultiplier tubes, is positioned adjacent to the scintillation crystal. The photomultiplier tubes receive the light photons from the scintillation crystal and produce electrical signals having amplitudes corresponding to the amount of light photons received. The electrical signals from the photomultiplier tubes are applied to position computing circuitry, wherein the location of the light event is determined, and the event location is then stored in a memory, from which an image of the radiation field can be displayed or printed.

FIG. 1 illustrates a gamma camera 10 comprising a Nal(TI) scintillation crystal 12. Generally, scintillation crystal 12 is large enough (10×10 cm) to image a significant part of the human body. An array of photodetectors 13, such as an array of photo-multiplier tubes (PMTs) having a plurality of PMTs 14, views scintillation crystal 12, to give positional sensitivity. Each PMT 14 has an X and a Y coordinate. When a photon is absorbed by scintillation crystal 12, light energy is generated in the form of visible light. A number of PMTs 14 receive the light via a respective light guide 16 and produce signals.

The X and Y coordinates of the event are determined by associated circuitry 18 using as a main parameter the strength of the signals generated by each PMT 14. The energy of the event is proportional to the sum of the signals, called the Z signal. Only Z signals within a given range are counted. A lead shield 20 surrounds the scintillation crystal 12, the array of photodetectors 13 and associated circuitry 18 to minimize background radiation.

Generally, a collimator 22 is placed between scintillation crystal 12 and the tissue. Commonly, collimator 22 is honeycomb-shaped, comprising a large number of holes separated by parallel lead septa. The purpose of collimator 22 is to intercept and eliminate gamma photon emissions that are not traveling in an accepted direction, i.e., parallel to the lead septa. Also, as shown by FIG. 2, a glass 24 is generally placed between the scintillation crystal 12 and the array of photodetectors 13.

A problem with prior art gamma cameras is that the surface of the scintillation crystal 12 which receives the gamma photon emissions is polished uniformly to produce a uniform light response function (LRF) with respect to the location of a given PMT as shown by FIG. 2, and hence a uniform image. As a result, the PMT 14 directly over the detected event (gamma ray interaction) receives most of the event's light photons yielding less than optimum spatial resolution. If the PMTs 14 are moved further away from the scintillation crystal 12 in order for the photons from an event directly under the given PMT 14 to be seen by more PMTs 14, the signal-to-noise ratio of the event degrades. Accordingly, for prior art gamma cameras, there is a trade-off between signal-to-noise ratio and spatial resolution.

One solution for this problem in the prior art is to place light absorbing shapes between the scintillation crystal and the PMTs for altering the light response function of the scintillation crystal. This method, however, causes the absorption of the light photons by the light absorbing shapes and therefore, degrades the energy resolution of the gamma camera.

Therefore, it is an aspect of the invention to provide a gamma camera yielding improved image quality with respect to spatial resolution for events detected directly under a PMT center, i.e., by increasing the number of event's light photons the surrounding PMTs receive, and improved signal-to-noise ratio without degrading the energy resolution of the gamma camera.

### SUMMARY OF THE INVENTION

With the foregoing and other aspects in view there is provided, in accordance with the invention, a gamma camera having an array of photodetectors and associated circuitry for detecting and converting light energy to electrical energy. The gamma camera further includes a scintillation crystal positioned in proximity to the array of photodetectors for detecting gamma photon emissions and generating light energy.

At least one portion of at least one surface of the scintillation crystal is polished differently than at least another portion for yielding a substantially different light response function for the generated light energy. That is, the scintillation crystal is non-uniformly polished or has a non-uniform level of smoothness. The non-uniformly polished scintillation crystal improves signal-to-noise ratio and image quality with respect to spatial resolution. The scintillation crystal is preferably sodium iodide-thallium activated (Nal(TI)) crystal.

The gamma camera in accordance with the invention further includes a collimator for intercepting and eliminating gamma photon emissions that are not traveling in an accepted direction. A lead shield is also provided and surrounds the scintillation crystal, the array of photodetectors and the associated circuitry for minimizing background radiation. Further, a glass is positioned between the scintillation crystal and the array of photodetectors.

The invention further provides a method for manufacturing a gamma camera. The method includes the steps of providing a scintillation crystal wherein at least one portion of the scintillation crystal yields a different light response function for light energy generated by the scintillation crystal than at least another portion of the scintillation crystal; providing an array of photodetectors having associated circuitry; and positioning the scintillation crystal in proximity to the array of photodetectors.

The at least one portion of the scintillation crystal is polished differently than the at least another portion for yielding the different light response function. That is, the scintillation crystal is non-uniformly polished or has a non-uniform level of smoothness. The non-uniformly polished scintillation crystal improves signal-to-noise ratio and image quality with respect to spatial resolution. The scintillation crystal is preferably sodium iodide-thallium activated (Nal(TI)) crystal. A glass is preferably positioned between the scintillation crystal and the array of photodectors.

### BRIEF DESCRIPTION OF THE DRAWINGS

The invention will become more clearly understood from the following detailed description in connection with the accompanying drawings, in which:

FIG. 1 is a schematic illustration of a prior art gamma camera;

FIG. 2 is a schematic illustration showing gamma ray interactions with a scintillation crystal of a prior art gamma camera;

FIG. 3 is a schematic illustration of a polished surface of a scintillation crystal in accordance with the present invention;

FIG. 4 is a schematic illustration showing gamma ray interactions with the scintillation crystal shown by FIG. 3; and

FIG. 5 is a schematic illustration of a gamma camera in accordance with the present invention.

### DETAILED DESCRIPTION OF THE PREFERRED EMBODIMENTS

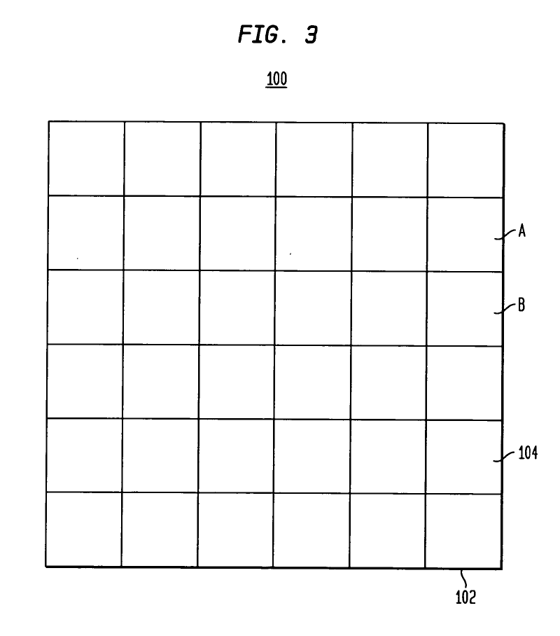

Referring now to FIG. 3, there is seen an exemplary embodiment of a scintillation crystal 100 for a gamma camera in accordance with the present invention. The scintillation crystal 100 is preferably sodium iodide-thallium activated (Nal(TI)) crystal.

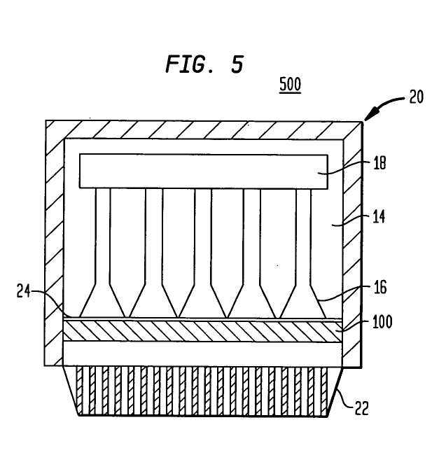

The scintillation crystal 100 includes a large surface area 102 for detecting gamma photon emissions. The scintillation crystal 100 also includes another large surface area 104 opposite surface area 102 for being viewed by an array of photodetectors 13 via glass 24 (see FIGS. 4 and 5). At least one of the surface areas 102, 104, and preferably, both surface areas 102, 104, includes a plurality of first areas A and a plurality of second areas B which are polished differently with respect to each other. That is, one or both of surfaces 102, 104 of the scintillation crystal 100 are non-uniformly polished or have a non-uniform level of smoothness. The array of photodetectors 13 is preferably an array of photo-multiplier tubes (PMTs) having a plurality of PMTs 14 as known in the art.

The different polishing or level of smoothness for the plurality of first areas A and the plurality of second areas B yield a different light response function (LRF) or non-uniform LRF for each of the areas A, B with respect to each other (see FIG. 4). That is, the plurality of areas A have a first light response function and the plurality of areas B have a second light response function which is different from the first light response function.

Even though two different light response functions are described hereinabove as being generated by the scintillation crystal 100, it is contemplated that three or more different light response functions can be generated by the scintillation crystal 100, if the scintillation crystal 100 is polished three or more different ways as shown by FIG. 4 (three different polished areas or areas having different levels of smoothness on at least one surface 102, 104 produce three different or non-uniform light response functions).

The light response functions describe or define the propagation paths of the light energy generated by the scintillation crystal 100. The light response functions can be characterized as being broad (LRF_1 in FIG. 4), where the light energy is viewed, for example, by three or more PMTs 14. The light response functions can also be characterized as being narrow (LRF_2, LRF_3 and LRF_4 in FIG. 4), where the light energy is viewed, for example, by one or two PMTs 14.

It is preferred that the plurality of areas A are substantially aligned with a respective central axis of a PMT 14 of the array of photodetectors 13 and yield a broader light response function for improving spatial resolution. Further, it is preferred that the plurality of areas B are not substantially aligned with a respective central axis of a PMT 14 of the array of photodetectors 13 and yield a narrower light response function for improving the signal-to-noise ratio. As such, in the preferred embodiment, the plurality of first areas A are polished more or made more smoother than the plurality of second areas B.

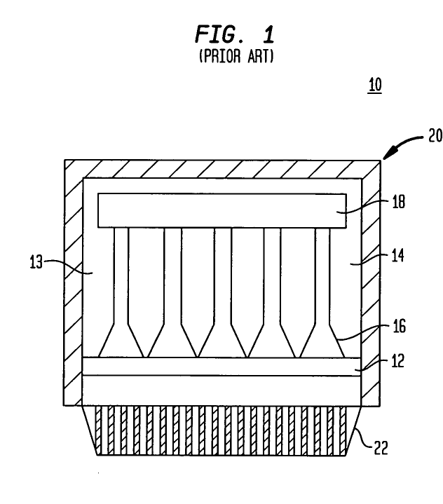

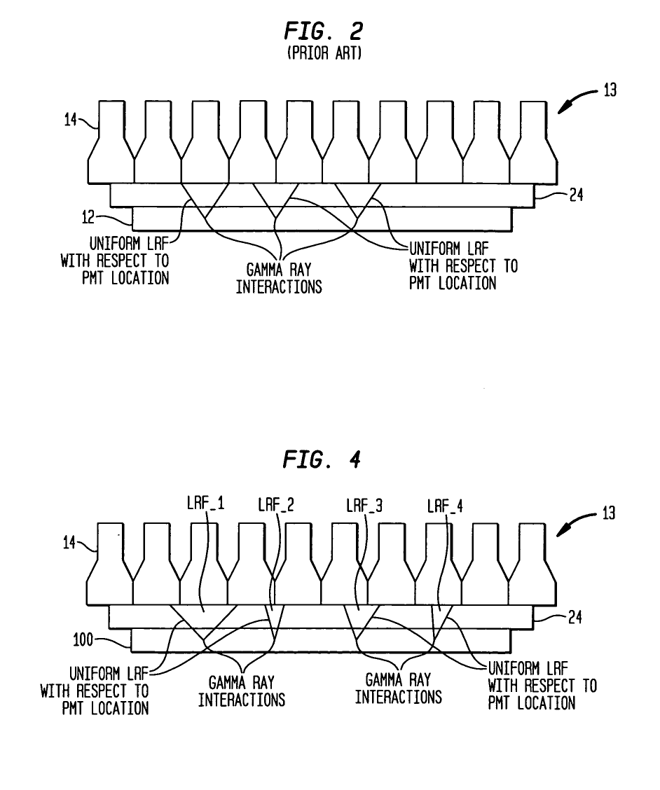

FIG. 5 is a schematic illustration of a gamma camera in accordance with the present invention and designated generally by reference numeral 500. The gamma camera 500 includes the same components as gamma camera 10 of the prior art and illustrated by FIG. 1. However, gamma camera 500 includes the inventive scintillation crystal 100 for providing two or more different light response functions for the generated light energy.

The invention further provides a method for manufacturing a gamma camera comprising the steps of providing a scintillation crystal wherein at least one portion of the scintillation crystal yields a different light response function for light energy generated by the scintillation crystal than at least another portion of the scintillation crystal as described above. The method further provides the steps of providing an array of photodetectors having associated circuitry and positioning the scintillation crystal in proximity to the array of photodetectors as shown by FIGS. 4 and 5.

The at least one portion of the scintillation crystal is polished differently than the at least another portion for yielding the different light response function as described above. That is, the scintillation crystal is non-uniformly polished or has a non-uniform level of smoothness. The non-uniformly polished scintillation crystal improves signal-to-noise ratio and image quality with respect to spatial resolution.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

1. A gamma camera for detecting gamma photon emissions and generating electrical energy comprising:
an array of photodetectors and associated circuitry for detecting and converting light energy to electrical energy; and
a scintillation crystal positioned in proximity to said array of photodetectors for detecting gamma photon emissions and generating said light energy, wherein at least one portion of at least one surface of said scintillation crystal yields a substantially different light response function for said generated light energy than at least another portion of said scintillation crystal.

2. The gamma camera according to claim 1, wherein said at least one portion of said scintillation crystal includes a plurality of uniformly polished areas, and wherein each of said plurality of uniformly polished areas is substantially aligned with a respective central axis of a photodetector of said array of photodetectors.

3. The gamma camera according to claim 1, wherein said at least one portion of said scintillation crystal includes a plurality of uniformly polished areas, and wherein each of said plurality of uniformly polished areas is positioned such that it is not substantially aligned with a respective central axis of a photodetector of said array of photodetectors.

4. The gamma camera according to claim 1, wherein said at least one portion of said scintillation crystal includes a first polished area of said scintillation crystal and said at least another portion of said scintillation crystal includes a second polished area of said scintillation crystal, and wherein said first and said second areas are polished differently to yield different light response functions for said generated light energy.

5. The gamma camera according to claim 1, further comprising a collimator for intercepting and eliminating gamma photon emissions that are not traveling in an accepted direction.

6. The gamma camera according to claim 1, wherein said scintillation crystal is sodium iodide-thallium activated (Nal(TI)) crystal.

7. The gamma camera according to claim 1, further comprising a lead shield surrounding said scintillation crystal, said array of photodetectors and said associated circuitry.

8. The gamma camera according to claim 1, further comprising a glass positioned between said scintillation crystal and said array of photodetectors.

9. An improved scintillation crystal for a gamma camera of the type comprising an array of photodetectors and associated circuitry for detecting and converting light energy to electrical energy, a collimator for directing gamma photon emissions towards said scintillation crystal, and a lead shield surrounding said scintillation crystal, said array of photodetectors and said associated circuitry, the improved scintillation crystal comprising:
at least one portion yielding a different light response function for light energy generated by said scintillation crystal than at least another portion of said scintillation crystal.

10. The improved scintillation crystal according to claim 9, wherein said at least one portion of said scintillation crystal includes a plurality of uniformly polished areas, and wherein each of said plurality of uniformly polished areas is substantially aligned with a respective central axis of a photodetector of said array of photodetectors.

11. The improved scintillation crystal according to claim 9, wherein said at least one portion of said scintillation crystal includes a plurality of uniformly polished areas, and wherein each of said plurality of uniformly polished areas is positioned such that it is not substantially aligned with a respective central axis of a photodetector of said array of photodetectors.

12. The improved scintillation crystal according to claim 9, wherein said at least one portion of said scintillation crystal includes a first polished area of said scintillation crystal and said at least another portion of said scintillation crystal includes a second polished area of said scintillation crystal, and wherein said first and said second polished areas are polished differently to yield different light response functions for said generated light energy.

13. The improved scintillation crystal according to claim 9, wherein said scintillation crystal is sodium iodide-thallium activated (Nal(TI)) crystal.

14. A method for manufacturing a gamma camera comprising the steps of:
providing a scintillation crystal wherein at least one portion of said scintillation crystal yields a different light response function for light energy generated by said scintillation crystal than at least another portion of said scintillation crystal;
providing an array of photodetectors having associated circuitry; and
positioning said scintillation crystal in proximity to said array of photodetectors.

15. The method according to claim 14, further comprising the step of surrounding said scintillation crystal, said array of photodetectors and associated circuitry with a lead shield.

16. The method according to claim 14, further comprising the step of providing a collimator in proximity to said scintillation crystal and opposite said array of photodetectors.

17. The method according to claim 14, wherein the step of providing a scintillation crystal comprises the step of polishing said at least one portion of said scintillation crystal for yielding said different light response function for light energy generated by said scintillation crystal than said at least another portion of said scintillation crystal.

18. The method according to claim 17, wherein said at least one polished portion of said scintillation crystal includes a plurality of uniformly polished areas, and wherein each of said plurality of uniformly polished areas is substantially aligned with a respective central axis of a photodetector of said array of photodetectors.

19. The method according to claim 17, wherein said at least one polished portion of said scintillation crystal includes a plurality of uniformly polished areas, and wherein each of said plurality of uniformly polished areas is positioned such that it is not substantially aligned with a respective central axis of a photodetector of said array of photodetectors.

20. The method according to claim 17, wherein said at least one portion of said scintillation crystal includes a first polished area of said scintillation crystal and said at least another portion of said scintillation crystal includes a second polished area of said scintillation crystal, wherein said first and said second polished areas are polished differently to yield different light response functions for said generated light energy.
